(19) United States
(12) Patent Application Publication
(10) Pub. No.: US 2019/0323390 A1
(43) Pub. Date: Oct. 24, 2019

(54) ENGINE VARIABLE COMPRESSION RATIO ARRANGEMENT

(71) Applicant: GM Global Technology Operations LLC, Detroit, MI (US)

(72) Inventors: Andrew G. Balding, Wixom, MI (US); Brad J. Heckman, Unionville, MI (US); Rodney E. Baker, Fenton, MI (US)

(21) Appl. No.: 15/956,217

(22) Filed: Apr. 18, 2018

(51) Int. Cl. F01L 13/08; F02D 15/02; F16H 1/32

(52) U.S. Cl. CPC F01L 13/08; F16H 2001/323; F16H 1/32; F02D 15/02

(57) ABSTRACT

An engine variable compression ratio arrangement can be equipped in an internal combustion engine. The engine variable compression ratio arrangement includes a planetary gear set. The planetary gear set receives rotational drive input from an engine crankshaft, and the planetary gear set transmits rotational drive output to an eccentric shaft. The rotational position of the eccentric shaft is shifted relative to the rotational position of the engine crankshaft by way of the planetary gear set. This shifting varies the compression ratio of the internal combustion engine.

### INTRODUCTION

The present disclosure relates to variable compression ratio technologies in internal combustion engines, and relates to ways to carry out compression ratio variation.

Variable compression ratio (VCR) technologies are employed in internal combustion engines in order to make changes to compression ratios established in combustion chambers amid engine operation. The changes are generally made in response to loads encountered during operation. In automobiles, VCR technologies have been shown to improve fuel efficiency by, for instance, operating the engine with higher compression ratios at lower loads. The technologies can be used in four-stroke and two-stroke engine strategies. One type of VCR technology makes use of a multi-link construction linking an engine piston and engine crankshaft, and makes use of an eccentric shaft.

### SUMMARY

In an embodiment, an engine variable compression ratio arrangement may include a sun gear, multiple planet gears, a ring gear, a planet gear carrier, and an actuator. The sun gear receives rotational drive input from an engine crankshaft. The planet gears are engaged with the sun gear. The ring gear is engaged with the planet gears and transmits rotational drive output to an eccentric shaft. The planet gear carrier supports rotation of the planet gears. And the actuator is coupled to the planet gear carrier. Upon actuation of the actuator, the rotational position of the planet gear carrier is altered which, in turn, shifts the rotational position of the eccentric shaft relative to the rotational position of the engine crankshaft for carrying out compression ratio variation.

In an embodiment, the engine variable compression ratio arrangement further includes a first gear that is mounted to the engine crankshaft. The first gear rotates with the engine crankshaft and is engaged with the sun gear.

In an embodiment, the sun gear includes a first set of teeth and a second set of teeth. The first set of teeth resides radially outboard of the second set of teeth. The first set of teeth is engaged with a first gear that is mounted to the engine crankshaft, and the second set of teeth is engaged with the planet gears.

In an embodiment, the engine variable compression ratio arrangement further includes a second gear that is mounted to the eccentric shaft. The second gear rotates with the eccentric shaft and is engaged with the ring gear.

In an embodiment, when the rotational position of the planet gear carrier is not altered by the actuator, the rotational position of the planet gear carrier remains stationary.

In an embodiment, the sun gear, planet gears, ring gear, and planet gear carrier together constitute a planetary gear set. The planetary gear set is configured about a primary axis. The actuator is situated generally in axial alignment with the primary axis.

In an embodiment, a first total axial length defined along the primary axis by the planetary gear set and by the actuator is less than a second total axial length defined along an engine crankshaft axis of the engine crankshaft.

In an embodiment, the sun gear, planet gears, and ring gear effect a speed reduction from the engine crankshaft to the eccentric shaft. The sun gear, planet gears, and ring gear also effect a torque increase from the engine crankshaft to the eccentric shaft.

In an embodiment, the engine variable compression ratio arrangement further includes a first gear and a second gear. The first gear is mounted to the engine crankshaft, and the second gear is mounted to the eccentric shaft. The first and second gear do not directly engage with each other.

In an embodiment, the sun gear, planet gears, ring gear, and planet gear carrier together constitute a planetary gear set. The planetary gear set is configured about a primary axis. The engine crankshaft is configured about an engine crankshaft axis. And the eccentric shaft is configured about an eccentric shaft axis. The primary axis, engine crankshaft axis, and eccentric axis are non-concentric with respect to one another.

In an embodiment, the actuator is an electric motor.

In an embodiment, an internal combustion engine includes the engine variable compression ratio arrangement.

In an embodiment, an engine variable compression ratio arrangement may include a planetary gear set, a first gear, and a second gear. The first gear transmits rotational drive output to the planetary gear set. The first gear is mounted to an engine crankshaft and rotates with the engine crankshaft. The second gear receives rotational drive input from the planetary gear set. The second gear is mounted to an eccentric shaft and rotates with the eccentric shaft. The eccentric shaft carries a variable compression ratio multi-link assembly. The planetary gear set effects a speed reduction from the first gear of the engine crankshaft to the second gear of the eccentric shaft, and effects a torque increase from the first gear of the engine crankshaft to the second gear of the eccentric shaft.

In an embodiment, the planetary gear set effects shifting of the rotational position of the eccentric shaft relative to the rotational position of the engine crankshaft in order to vary the compression ratio by way of the variable compression ratio multi-link assembly.

In an embodiment, a primary axis of the planetary gear set, an engine crankshaft axis of the engine crankshaft, and an eccentric shaft axis of the eccentric shaft are non-concentric with respect to one another.

In an embodiment, the engine variable compression ratio arrangement further includes an actuator. The actuator is coupled to the planetary gear set. Actuation of the actuator causes the rotational position of the eccentric shaft to shift relative to the rotational position of the engine crankshaft. This shifting varies the compression ratio by way of the variable compression ratio multi-link assembly.

In an embodiment, the planetary gear set includes a sun gear, multiple planet gears, and a ring gear. The sun gear is engaged with the first gear. The planet gears are engaged with the sun gear. And the ring gear is engaged with the planet gears, and is engaged with the second gear.

In an embodiment, the planetary gear set is configured about a primary axis. An actuator is coupled to the planetary gear set and is configured about the primary axis. An engine oil pump is configured about the primary axis. A first total axial length is defined along the primary axis by the planetary gear set, by the actuator, and by the engine oil pump. A second total axial length is defined along an engine crankshaft axis of the engine crankshaft. The first total axial length is less than the second total axial length.

In an embodiment, an engine variable compression ratio arrangement may include a planetary gear set and an actuator. The planetary gear set includes a sun gear, planet gears, a ring gear, and a planet gear carrier. The sun gear receives rotational drive input from an engine crankshaft. The planet gears are engaged with the sun gear. The ring gear is engaged with the planet gears and transmit rotational drive output to an eccentric shaft. The planet gear carrier supports rotation of the planet gears. The actuator is coupled to the planet gear carrier. Actuation of the actuator alters the rotational position of the planet gear carrier which, in turn, shifts the rotational position of the eccentric shaft relative to the rotational position of the engine crankshaft for compression ratio variation. The planetary gear set effects a torque increase from the engine crankshaft to the eccentric shaft. The planetary gear set, engine crankshaft, and eccentric shaft are configured about different axes with respect to one another.

In an embodiment, the planetary gear set is configured about a primary axis. The actuator is configured about the primary axis. A first total axial length is defined along the primary axis by the planetary gear set and by the actuator. A second total axial length is defined along an engine crankshaft axis of the engine crankshaft. The first total axial length is less than the second total axial length.

### BRIEF DESCRIPTION OF THE DRAWINGS

One or more aspects of the disclosure will hereinafter be described in conjunction with the appended drawings, wherein like designations denote like elements, and wherein:

FIG. 1 is a perspective view of components of an internal combustion engine, showing an embodiment of an engine variable compression ratio arrangement;

FIG. 2 is another perspective view of the internal combustion engine components and engine variable compression ratio arrangement of FIG. 1;

FIG. 3 is an end view of the internal combustion engine components and engine variable compression ratio arrangement of FIG. 1;

FIG. 4 is an enlarged bottom view of the engine variable compression ratio arrangement of FIG. 1;

FIG. 5 is a sectional view of an embodiment of a planetary gear set of the engine variable compression ratio arrangement of FIG. 1; and

FIG. 6 is a schematic of the engine variable compression ratio arrangement of FIG. 1.

### DETAILED DESCRIPTION

Referring to the drawings, an engine variable compression ratio arrangement is designed and constructed to furnish high torque phasing for variable compression ratio (VCR) technologies, while satisfying packaging demands in internal combustion engine applications. In the embodiment presented, a planetary gear set is used to carry out the phasing functionality of VCR systems. The engine variable compression ratio arrangement effects a necessary speed reduction and torque increase, and has a relatively compact configuration that does not add to the overall package length of the associated internal combustion engine. By providing these advancements, as well as others set forth below, VCR technologies can be more effectively and efficiently employed in internal combustion engines. The engine variable compression ratio arrangement is described below in the context of an automotive application, yet could be equipped in non-automotive applications as well.

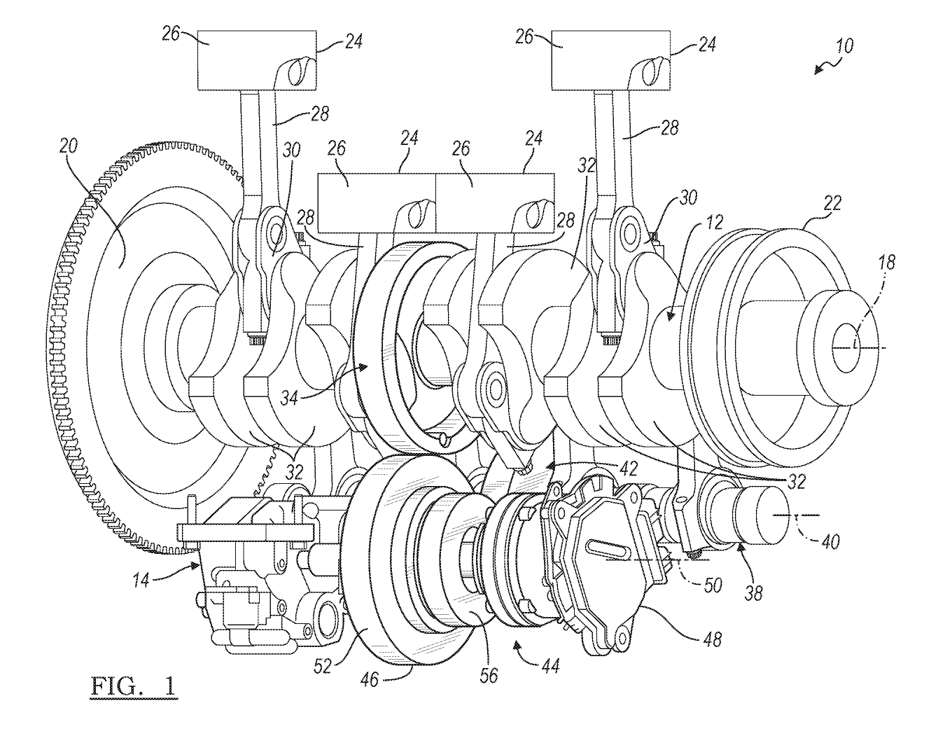

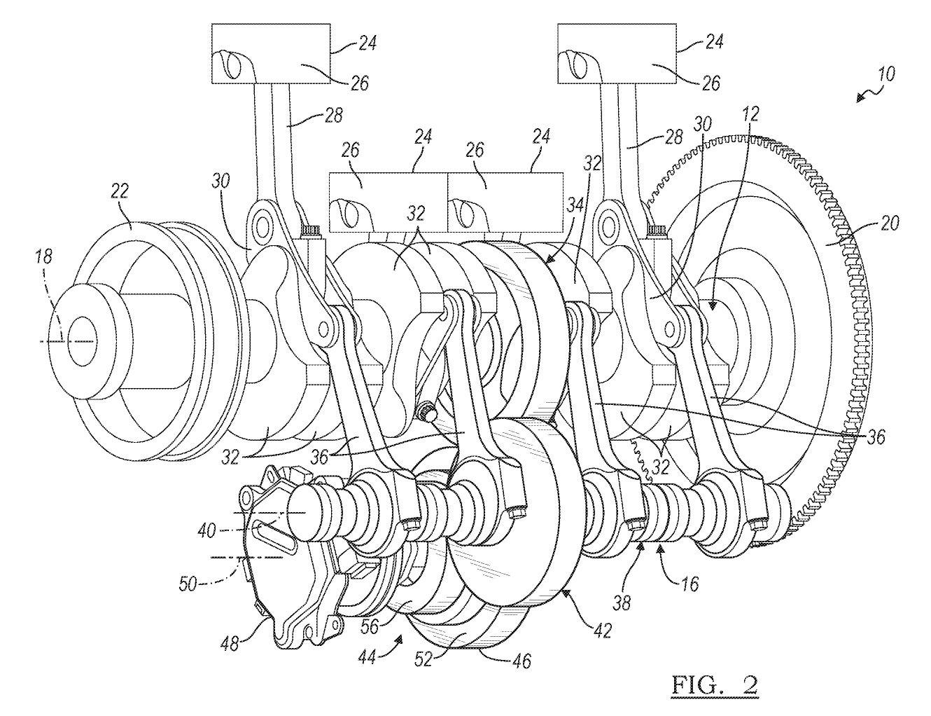

Referring now to FIGS. 1 and 2, an internal combustion engine 10 is equipped with VCR technologies in order to make changes to compression ratios established in combustion chambers amid engine operation. The internal combustion engine 10 has various constructions and components not presented in the figures, but will be known by skilled artisans, and can have different designs, constructions, and components in different applications and embodiments. In the example of FIGS. 1 and 2, the internal combustion engine 10 operates with a four-stroke cycle and includes an engine crankshaft 12, an engine oil pump 14, and a variable compression ratio (VCR) multi-link assembly 16. The engine crankshaft 12 is configured about an engine crankshaft axis 18 and revolves therearound amid operation. At a first end, the engine crankshaft 12 has mounted to it a flywheel 20, and at a second end, the engine crankshaft 12 has mounted to it a camshaft sprocket 22. Between the first and second ends, the engine crankshaft 12 carries multiple pistons 24, each with a head 26 and a connecting rod 28. An intermediate linkage 30 couples the connecting rods 28 to the engine crankshaft 12. Further, counterweights 32 are carried by the engine crankshaft 12 between its ends. At an approximate axial midpoint, a first gear 34 is mounted to the engine crankshaft 12. The first gear 34 is fixed to the engine crankshaft 12 and rotates with the engine crankshaft 12. The first gear 34 has a set of external teeth around its circumference (the figures are schematic representations in some regards and lack precise depiction of such external teeth).

The engine oil pump 14 is situated below the engine crankshaft 12 in terms of the overall architecture of the internal combustion engine 10. Referring now particularly to FIG. 2, the VCR multi-link assembly 16 includes links 36 extending between the intermediate linkages 30 and an eccentric shaft 38. The links 36 are coupled to the intermediate linkages 30 and are coupled to the eccentric shaft 38. The eccentric shaft 38 is configured about an eccentric shaft axis 40 and revolves therearound amid operation. As described more below, the rotational position of the eccentric shaft 38 is shifted in order to change the compression ratio of the internal combustion engine 10 via the VCR multi-link assembly 16. A second gear 42 is mounted to the eccentric shaft 38 and fixed thereto. The second gear 42 hence rotates with the eccentric shaft 38. Like the first gear 34, the second gear 42 has a set of external teeth around its circumference. As perhaps demonstrated best by FIG. 6, the second gear 42 lacks direct engagement with the first gear 34; in other words, the external teeth of the first gear 34 do not mesh with the external teeth of the second gear 42.

The internal combustion engine 10 further includes an engine variable compression ratio (VCR) arrangement 44. The engine VCR arrangement 44 is a multi-piece assembly with components that work together to provide the high torque phasing required to vary the compression ratio of the internal combustion engine 10 amid engine operation, and does so with a relatively compact configuration that does not enlarge the overall package length of the internal combustion engine 10. The engine VCR arrangement 44 can have different designs, constructions, and components in different embodiments depending upon, among other factors, the designs and constructions and components of the associated internal combustion engine in which the engine VCR arrangement 44 is equipped. In the embodiment of the figures, the engine VCR arrangement 44 is situated in-line with the engine oil pump 14 and is contained generally within a crankcase of the internal combustion engine 10. The engine VCR arrangement 44 includes a planetary gear set 46 and an actuator 48, and can also include the first and second gears 34, 42 described above.

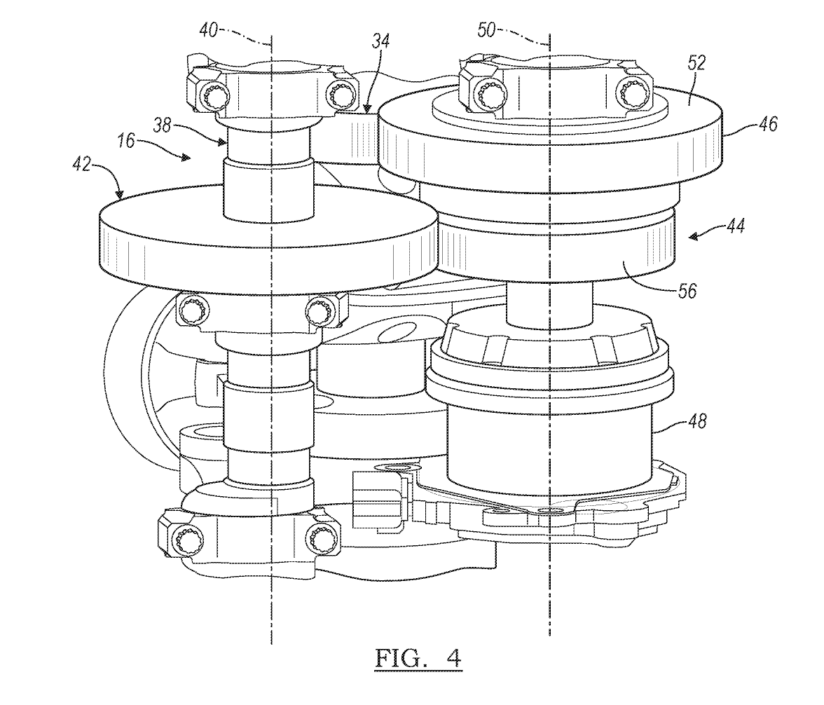

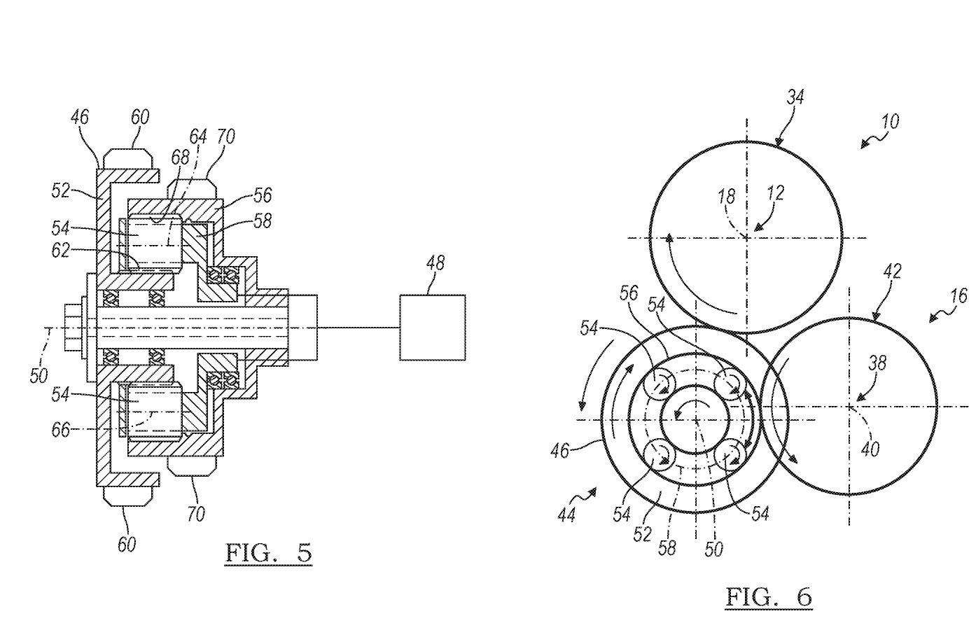

The planetary gear set 46 is situated between the first and second gears 34, 42 and transmits rotation therebetween. The first gear 34 transmits rotational drive output to the planetary gear set 46, and the second gear 42, in turn, receives rotational drive input from the planetary gear set 46—in this way, rotation of the engine crankshaft 12 translates into rotation of the eccentric shaft 38 via the planetary gear set 46. The planetary gear set 46 can have different designs, constructions, and components in different embodiments. In the embodiment presented in the figures, and referring now to FIGS. 1 and 4-6, the planetary gear set 46 is configured about a central and primary axis 50 and includes a sun gear 52, planet gears 54, a ring gear 56, and a planet gear carrier 58. The sun gear 52 engages directly with the first gear 34 and receives direct and immediate rotational drive input from the first gear 34 (“direct” in this context refers to an engagement that lacks an intervening component therebetween). For engagement with the first gear 34, the sun gear 52 has a first set of teeth 60 (FIG. 5) located externally thereon and extending radially outward with respect to the annular shape of the sun gear 52. The first set of teeth 60 makes teeth-to-teeth meshing with the set of external teeth of the first gear 34. Residing generally radially inboard of the first set of teeth 60, the sun gear 52 also has a second set of teeth 62 (FIG. 5) located internally thereof and, again, extending radially outward with respect to the annular shape of the sun gear 52. The second set of teeth 62 makes teeth-to-teeth meshing with sets of teeth of the planet gears 54.

Referring now to FIGS. 5 and 6, the planet gears 54 engage directly with the sun gear 52 and receive direct and immediate revolving drive input from the sun gear 52. When the rotational position of the eccentric shaft 38 is not in the midst of being shifted, the planet gears 54 each revolve about their own individual axes and do not rotate about the primary axis 50—for example, and with specific reference to FIG. 5, the planet gears 54 depicted each revolve about their respective individual axes 64, 66. In the embodiment presented in the figures, there are a total of four discrete planet gears 54 with similar designs and constructions, but there could be other quantities of planet gears such as three or six. However many there are, each of the planet gears 54 engages directly with the ring gear 56, and each planet gear 54 has a set of external teeth around its circumference for making teeth-to-teeth meshing with teeth of the ring gear 56, in addition to teeth-to-teeth meshing with the sun gear 52.

The ring gear 56 receives direct and immediate rotational drive input from the planet gears 54, and engages directly with the second gear 42 and transmits direct and immediate rotational drive output to the second gear 42. For engagement with the planet gears 54, the ring gear 56 has a first set of teeth 68 located internally thereon and that extend radially inward with respect to the annular components of the planetary gear set 46. And for engagement with the second gear 42, the ring gear has a second set of teeth 70 located externally thereon and that extend radially outward with respect to the annular components of the planetary gear set 46. The second set of teeth 70 makes teeth-to-teeth meshing with the set of external teeth of the second gear 42.

Still referring to FIGS. 5 and 6, the planet gear carrier 58 supports revolution of the planet gears 54 about their respective axes. When the rotational position of the eccentric shaft 38 is not in the midst of being shifted, the planet gear carrier 58 does not itself rotate and instead its rotational position remains stationary while the other components of the planetary gear set 46 rotate and revolve. The actuator 48 is coupled to the planet gear carrier 58 and, upon activation and actuation, alters the rotational position of the planet gear carrier 58. The actuator 48 can be coupled to the planet gear carrier in various ways including via a mechanical interconnection involving bolting, or some other way. The actuator 48 in this embodiment is of the rotary type and has an electric motor, but could be another type of actuator such as a hydraulic actuator in other embodiments. Like the engine oil pump 14, the actuator 48 is configured about the primary axis 50 and is situated in general axial alignment with the primary axis 50.

As described, FIG. 5 presents one example of an embodiment of the planetary gear set 46, but it should be appreciated that other example embodiments of the planetary gear set 46 are possible with various designs and constructions of sun gears, planet gears, ring gears, and planet gear carriers. For instance, a different gear of the planetary gear set 46 other than the sun gear 52 could engage directly with the first gear 34 and therefore receive direct and immediate rotational drive input from the first gear 34; and similarly, a different gear of the planetary gear set 46 other than the ring gear 56 could engage directly with the second gear 42 and therefore transmit direct and immediate rotational drive output to the second gear 42.

In an operating state in which the eccentric shaft 38 is not in the midst of shifting, the engine crankshaft 12 rotates and, as a consequence, the first gear 34 rotates as well. The first gear 34 drives rotation of the sun gear 52 via their intermeshing teeth. The sun gear 52 causes the planet gears 54 to revolve in place which, in turn, rotates the ring gear 56. Due to their intermeshing teeth, the second gear 42 is driven to rotate by the ring gear 56. The eccentric shaft 38, having the second gear 42 mounted to it, is hence driven to rotate. Under this operating state, the planet gear carrier 58 does not itself rotate about the primary axis 50 and rather remains rotationally static relative to the primary axis 50. Furthermore, the actuator 48 stays deactivated in this state. Amid these rotations and between the engine crankshaft 12 and the eccentric shaft 38, a rotational speed reduction and a torque increase is furnished—this is demanded in certain VCR systems. In an example, the rotational speed reduction from the engine crankshaft 12 to the eccentric shaft 38 is approximately halved (i.e., the engine crankshaft 12 rotates at twice the speed of the eccentric shaft 38), and the torque increase from the engine crankshaft 12 to the eccentric shaft 38 is approximately doubled (i.e., the engine crankshaft 12 exerts a torque which is one-half the torque exerted by the eccentric shaft 38). This rotational speed reduction and torque increase is established by way of various relationships among the gears of the engine VCR arrangement 44. Other magnitudes of rotational speed decrease and of torque increase can be furnished by other examples and other embodiments.

In order to make changes to the compression ratio of the internal combustion engine 10, the rotational position of the eccentric shaft 38 is shifted relative to the rotational position of the engine crankshaft 12. In other words, the eccentric shaft 38 is angularly displaced (clockwise or counterclockwise) with respect to the rotational position of the engine crankshaft 12. In an illustration of shifting, the eccentric shaft 38 moves from a first rotational position thereof to a second rotational position thereof relative to the same rotational position of the engine crankshaft 12. To initiate shifting, the actuator 48 is activated and—due to its coupling to the planet gear carrier 58—alters the rotational position of the planet gear carrier 58. Unlike the previous operating state described above, amid shifting the planet gear carrier 58 rotates about the primary axis 50 and is no longer static in this regard. Rotation of the planet gear carrier 58 in this operating state drives rotation of the ring gear 56. The ring gear 56 in turn drives rotation of the second gear 42, which shifts the rotational position of the eccentric shaft 38 relative to the rotational position of the engine crankshaft 12. The eccentric shaft's position can be shifted as desired to change the compression ratio of the internal combustion engine 10.

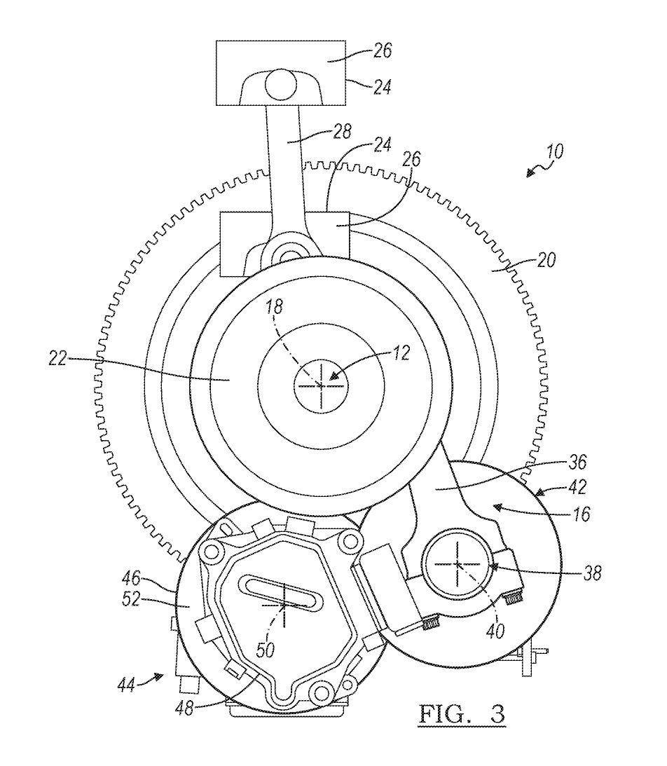

The engine VCR arrangement 44 is designed and constructed to satisfy—or at least not substantially enlarge—packaging demands in an automotive internal combustion engine which can oftentimes be exacting and inflexible. The planetary gear set 46 is configured about the primary axis 50, along with the engine oil pump 14 and the actuator 48; these three components thus share the common centerline of the primary axis 50. Still, in other embodiments the engine oil pump 14 need not be configured about the primary axis 50. Situating the planetary gear set 46 off-axis relative to the engine crankshaft axis 18 averts an addition to the overall package length of the internal combustion engine 10 which might otherwise occur. Furthermore, although parallel, the primary axis 50, engine crankshaft axis 18, and eccentric shaft axis 40 are all non-concentric with respect to one another (this is perhaps demonstrated best by FIGS. 3 and 6). Moreover, the total axial length occupied by the components situated along the primary axis 50 is less than that of the engine crankshaft 12. In particular, a first total axial length taken along the primary axis 50 and measured axially and lengthwise end-to-end between the engine oil pump 14 and the actuator 48, or measured axially and lengthwise between the planetary gear set 46 and the actuator 48, is less than a second total axial length taken along the engine crankshaft axis 18 and measured axially and lengthwise between the first and second ends of the engine crankshaft 12. Fulfilling one or more of the above relationships may facilitate the satisfaction of certain packaging demands in a given application, but the engine VCR arrangement 44 need not necessarily fulfill all or any of them in a particular embodiment.

It is to be understood that the foregoing is a description of one or more aspects of the disclosure. The disclosure is not limited to the particular embodiment(s) disclosed herein, but rather is defined solely by the claims below. Furthermore, the statements contained in the foregoing description relate to particular embodiments and are not to be construed as limitations on the scope of the disclosure or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

What is claimed is:

1. An engine variable compression ratio arrangement, comprising:
a sun gear receiving rotational drive input from an engine crankshaft;
a plurality of planet gears engaged with the sun gear;
a ring gear engaged with the plurality of planet gears and transmitting rotational drive output to an eccentric shaft;
a planet gear carrier supporting rotation of the plurality of planet gears; and
an actuator coupled to the planet gear carrier;
wherein actuation of the actuator alters the rotational position of the planet gear carrier which, in turn, shifts the rotational position of the eccentric shaft relative to the rotational position of the engine crankshaft for compression ratio variation.

2. The engine variable compression ratio arrangement of claim 1, further comprising a first gear mounted to the engine crankshaft and rotating with the engine crankshaft, the first gear engaged with the sun gear.

3. The engine variable compression ratio arrangement of claim 1, wherein the sun gear comprises a first set of teeth and a second set of teeth, the first set of teeth residing radially outboard of the second set of teeth, the first set of teeth engaged with a first gear mounted to the engine crankshaft, and the second set of teeth engaged with the plurality of planet gears.

4. The engine variable compression ratio arrangement of claim 1, further comprising a second gear mounted to the eccentric shaft and rotating with the eccentric shaft, the second gear engaged with the ring gear.

5. The engine variable compression ratio arrangement of claim 1, wherein, when the rotational position of the planet gear carrier lacks altering via the actuator, the rotational position of the planet gear carrier remains stationary.

6. The engine variable compression ratio arrangement of claim 1, wherein the sun gear, plurality of planet gears, ring gear, and planet gear carrier together constitute a planetary gear set configured about a primary axis, and wherein the actuator is situated generally in axial alignment with the primary axis.

7. The engine variable compression ratio arrangement of claim 6, wherein a first total axial length defined along the primary axis by the planetary gear set and by the actuator is less than a second total axial length defined along an engine crankshaft axis of the engine crankshaft.

8. The engine variable compression ratio arrangement of claim 1, wherein the sun gear, plurality of planet gears, and ring gear effect a speed reduction from the engine crankshaft to the eccentric shaft, and effect a torque increase from the engine crankshaft to the eccentric shaft.

9. The engine variable compression ratio arrangement of claim 1, further comprising a first gear mounted to the engine crankshaft and a second gear mounted to the eccentric shaft, and wherein the first and second gears lack direct engagement with each other.

10. The engine variable compression ratio arrangement of claim 1, wherein the sun gear, plurality of planet gears, ring gear, and planet gear carrier together constitute a planetary gear set configured about a primary axis, the engine crankshaft is configured about an engine crankshaft axis, and the eccentric shaft is configured about an eccentric shaft axis, and wherein the primary axis, engine crankshaft axis, and eccentric shaft axis are non-concentric with respect to one another.

11. The engine variable compression ratio arrangement of claim 1, wherein the actuator has an electric motor.

12. An internal combustion engine comprising the engine variable compression ratio arrangement of claim 1.

13. An engine variable compression ratio arrangement, comprising:
a planetary gear set;
a first gear transmitting rotational drive output to the planetary gear set, the first gear being mounted to an engine crankshaft and rotating with the engine crankshaft; and
a second gear receiving rotational drive input from the planetary gear set, the second gear being mounted to an eccentric shaft and rotating with the eccentric shaft, the eccentric shaft carrying a variable compression ratio multi-link assembly;
wherein the planetary gear set effects a speed reduction from the first gear of the engine crankshaft to the second gear of the eccentric shaft, and wherein the planetary gear set effects a torque increase from the first gear of the engine crankshaft to the second gear of the eccentric shaft.

14. The engine variable compression ratio arrangement of claim 13, wherein the planetary gear set effects shifting of the rotational position of the eccentric shaft relative to the rotational position of the engine crankshaft in order to vary the compression ratio via the variable compression ratio multi-link assembly.

15. The engine variable compression ratio arrangement of claim 13, wherein a primary axis of the planetary gear set, an engine crankshaft axis of the engine crankshaft, and an eccentric shaft axis of the eccentric shaft are non-concentric with respect to one another.

16. The engine variable compression ratio arrangement of claim 13, further comprising an actuator coupled to the planetary gear set, and wherein upon actuation of the actuator the rotational position of the eccentric shaft is shifted relative to the rotational position of the engine crankshaft in order to vary the compression ratio via the variable compression ratio multi-link assembly.

17. The engine variable compression ratio arrangement of claim 16, wherein the planetary gear set includes a sun gear engaged with the first gear, a plurality of planet gears engaged with the sun gear, and a ring gear engaged with the plurality of planet gears and engaged with the second gear.

18. The engine variable compression ratio arrangement of claim 13, wherein the planetary gear set is configured about a primary axis, an actuator coupled to the planetary gear set is configured about the primary axis, and an engine oil pump is configured about the primary axis, and wherein a first total axial length defined along the primary axis by the planetary gear set, by the actuator, and by the engine oil pump is less than a second total axial length defined along an engine crankshaft axis of the engine crankshaft.

19. An engine variable compression ratio arrangement, comprising:
a planetary gear set including a sun gear receiving rotational drive input from an engine crankshaft, a plurality of planet gears engaged with the sun gear, a ring gear engaged with the plurality of planet gears and transmitting rotational drive output to an eccentric shaft, and a planet gear carrier supporting rotation of the plurality of planet gears; and
an actuator coupled to the planet gear carrier;
wherein actuation of the actuator alters the rotational position of the planet gear carrier which, in turn, shifts the rotational position of the eccentric shaft relative to the rotational position of the engine crankshaft for compression ratio variation, wherein the planetary gear set effects a torque increase from the engine crankshaft to the eccentric shaft, and wherein the planetary gear set, engine crankshaft, and eccentric shaft are configured about different axes with respect to one another.

20. The engine variable compression ratio arrangement of claim 19, wherein the planetary gear set is configured about a primary axis and the actuator is configured about the primary axis, and wherein a first total axial length defined along the primary axis by the planetary gear set and by the actuator is less than a second total axial length defined along an engine crankshaft axis of the engine crankshaft.
